(19) United States
(12) Patent Application Publication
(10) Pub. No.: US 2022/0039587 A1
(43) Pub. Date: Feb. 10, 2022

(54) DOMESTIC MACHINE FOR DISPENSING FILTERED, HOT, COLD AND CARBONATED BEVERAGE WITH BEVERAGE CAPSULE SYSTEM

(71) Applicant: EPPOX, Saint de Gonville (FR)

(72) Inventor: Dominique De Freitas, Saint de Gonville (FR)

(73) Assignee: EPPOX, Saint de Gonville (FR)

(21) Appl. No.: 17/395,028

(22) Filed: Aug. 5, 2021

(30) Foreign Application Priority Data
Aug. 5, 2020 (EP) 20189684.2

(51) Int. Cl. A47J 31/40; A47J 31/54; A47J 31/60; A47J 31/46; A47J 31/52

(52) U.S. Cl. CPC A47J 31/407; A47J 31/54; A47J 31/605; A23L 2/54; A47J 31/468; A47J 31/52; A47J 31/461

(57) ABSTRACT

The invention relates to a domestic machine for dispensing beverage, comprising a removable water tank, a water filtration system, at least one circulation pump for moving the water to a dispensing point associated with a beverage capsule, the machine comprising a heating section comprising a heater configured to heat the water to be dispensed, a cooling section comprising a cooling device configured to cool the water to be dispensed, and a carbonating section comprising a carbonating device configured to dissolve CO₂ in the water to be dispensed, the machine comprising a control panel for selecting a hot drink, a cold drink or a carbonated drink, by activating at least one of said sections.

### CROSS-REFERENCE TO RELATED APPLICATIONS

This application claims the benefit of European Patent application no. EP20189684.2, filed on Aug. 5, 2020.

### TECHNICAL FIELD

The invention relates to the field of domestic beverage dispensing machines, in particular of the small household appliance type.

### BACKGROUND

In this field, it is known to provide coffee machines of various types. Some coffee machines require preparation and optionally grinding of the coffee before the machine can prepare the corresponding drink and dispense it into a cup. Other machines use a coffee capsule that is pierced by the machine and the content of which is used by the machine to brew coffee without the need for preparation.

Other machines are used to make juices. These machines require cutting fruits and mixing them in an extractor.

Other machines make it possible to make carbonated drinks in which CO₂ is dissolved in the drink. These machines incorporate a pressurized CO₂ cartridge and an assembly comprising a straw to be immersed in the drink to be carbonated.

Unfortunately, in a desire to obtain several types of drinks, it is necessary to have several different machines which can be cumbersome for home use.

Thus, a first objective of the present invention is to provide a compact beverage dispensing machine making it possible to dispense different types of beverages.

A second objective is to provide a machine in which preparation by the user prior to using the machine is reduced to a minimum.

To achieve these objectives, the invention provides a domestic machine for dispensing beverage, comprising a removable water tank, a water filtration system, at least one circulation pump for moving the water to a dispensing point associated with a beverage capsule, the machine comprising a heating section comprising a heater configured to heat the water to be dispensed, a cooling section comprising a cooling device configured to cool the water to be dispensed, and a carbonating section comprising a carbonating device configured to dissolve CO₂ in the water to be dispensed, the machine comprising a control panel for selecting a hot drink, a cold drink or a carbonated drink, by activating at least one of said sections.

Advantageously, the machine is a domestic machine for dispensing a hot drink, a cold drink, a carbonated drink, in several flavors by means of capsules of various types and flavors (coffee, tea, juice, sparkling water, soda, etc.).

According to one aspect, the cooling section is combined with the carbonating section, so as to enable dispensing a cold carbonated drink.

Advantageously, this arrangement makes it possible to produce a cold carbonated drink. In addition, the low temperature of the drink makes it possible to retain more dissolved CO₂, which means that the drink obtained is more carbonated.

### SUMMARY

According to other aspects taken solely or in any technically feasible combination:
the machine comprises an internal tank forming a refrigerated chamber and/or cooperating with at least one coil of the cooling device; and further cooperating with means for dispensing cold water and carbonated cold water; and/or
the machine comprises a removable CO₂ cartridge connected to the carbonating device; and/or
the filtration system includes a removable filter cartridge; and/or
the water tank is in the form of a carafe, preferably having a substantially prismatic body, comprising a valve on a lower face cooperating with a sampling pipe; and/or
the carafe comprises a massive handle arranged on a front face of the machine comprising a dispensing support; and/or
the carafe has an upper sliding valve; and/or
the machine comprises a body block and two side blocks one in front of the other, the front block being formed by the carafe, and the rear block forming a compartment, the front face of which is formed by the carafe.
the rear block forms a gas cartridge housing; and/or
the body block comprises a side sub-block closed by a side flap; and/or
the body block comprises a side sub-block closed by the carafe; and/or
the side sub-block forms a filter cartridge housing.

Another aspect of the invention relates to a use of a beverage carbonation means, a juice production means and a hot beverage production means, in a compact assembly in a machine according to the invention; and/or a method of assembling a machine combining a beverage carbonation means, a juice production means and a hot beverage production means compactly in a domestic machine according to the invention.

### BRIEF DESCRIPTION OF THE DRAWINGS

The invention will be further detailed by the description of non-limiting embodiments, and on the basis of the appended figures illustrating non-limiting variants of the invention, among which:

FIG. 1 schematically illustrates a space view of a dispensing machine according to a preferred embodiment;

FIG. 2 schematically illustrates a space view similar to the previous figure, but where the carafe is removed.

FIG. 3 schematically illustrates the dispensing circuit of the dispensing machine according to a first preferred embodiment;

FIG. 4 schematically illustrates the dispensing circuit of the dispensing machine according to a second preferred embodiment;

FIG. 5 schematically illustrates a space view of a beverage capsule.

FIG. 6 schematically illustrates a side view of the beverage capsule of the previous figure.

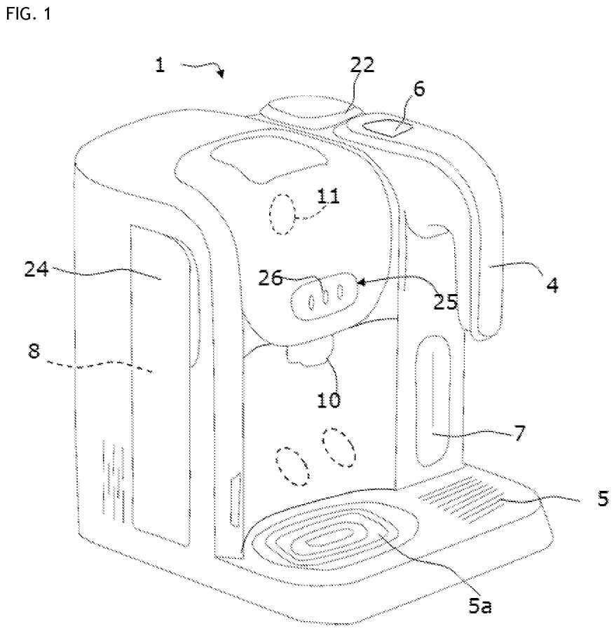

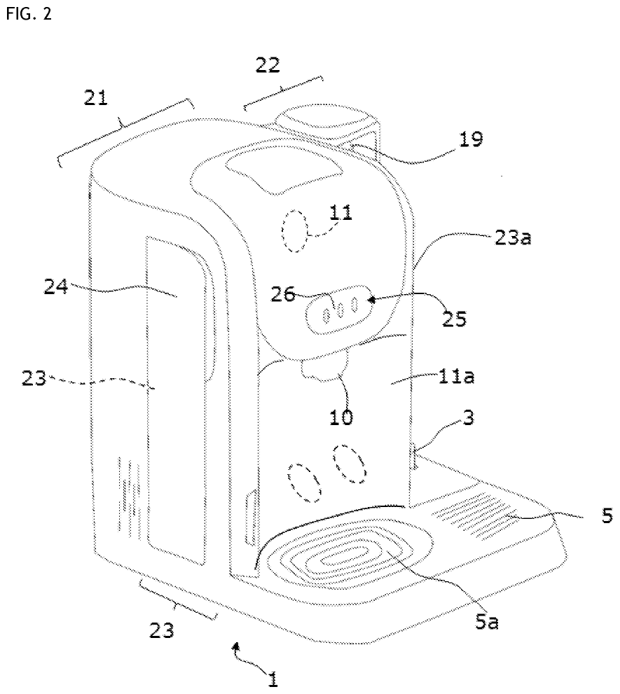

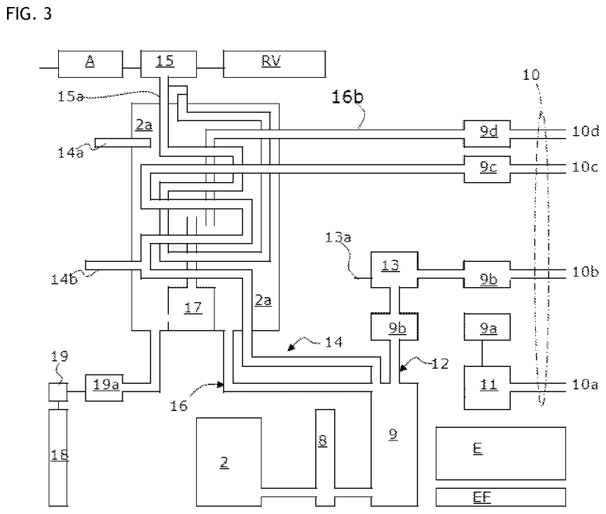

### DETAILED DESCRIPTION

The invention relates to a domestic beverage dispensing machine 1. It is a machine of the small household appliance type.

The machine includes a removable water tank 2. In particular, the water tank 2 is in the form of a carafe, preferably having a substantially prismatic body. The carafe comprises a valve (not shown) preferably on a lower face cooperating with a sampling pipe 3. The machine 1 measures for example H300×W280×D300 mm.

A tank 2 is preferable to an intake from a water supply network because there is no complex plumbing installation to operate the machine 1.

The sampling pipe 3 is connected to a specific pump which may be the one described below. Advantageously, a lower tube 3 makes it possible to take advantage of gravity for drawing water, and makes it possible to take almost all of the water from the carafe (2). The tank 2 has for example a capacity of 2.5 L and measures for example H285×W70×D145 mm.

Preferably, the carafe (2) comprises a massive handle 4 disposed on a front face of the machine 1. The front face comprises a beverage holder 5, lateral with respect to a dispensing holder 5a at a dispensing point. The dispensing holder 5a measures for example H150×W140×D100 mm.

Advantageously, this makes it possible to achieve a compact arrangement by making use of the space above a front beverage holder 5 to produce a massive handle 4 for a good grip of the carafe (2). In addition, it makes it possible to achieve an aesthetic shape of large size.

In the illustrated variant, the carafe (2) comprises an upper sliding valve 6. The valve 6 is used to fill the carafe. For example, it is slid backwards to open the carafe and closed when in use on machine 1.

The tank 2 can include a level window 7 to check the filling level.

The machine 1 further comprises a filtration system 8 for the water. Preferably, the filtration system 8 comprises a removable filter cartridge, for example a charcoal filter of H250×W60×D60 mm.

The filtration system 8 is placed downstream of the water tank 2. It filters elements of the water in the carafe such as micro-debris or dust.

The machine 1 further comprises at least one circulation pump 9 for moving the water to a dispensing point 10. The dispensing point is associated with a beverage capsule 11 which can be used for the dispensing of drinks. A capsule housing is provided for this purpose. The pump 9 is disposed downstream of the filtration system 8. Preferably, the machine comprises capsule detection means such as an optical detector or other suitable technology.

The machine 1 therefore comprises a dispensing circuit from the tank 2 to the filtration system 8 then to the pump 9. After certain elements of the dispensing circuit detailed below, the water arrives at a dispensing point 10 in order to be able to be dispensed as a beverage.

The invention proposes a machine 1 which can operate with capsules 11. Thus, capsules 11 can be placed on the dispensing circuit, via a specific bypass or preferably via a specific dispensing circuit so that the contents of the capsule 11 and water are used to dispense the beverage obtained. This is in particular a capsule 11 of a concentrated drink.

Alternatively, in the case of a drink prepared with a capsule 11, the content of the capsule 11 is conveyed into a dispensing container, then water from the circuit dissolves said content of capsule 11 in said beverage container.

In particular, a capsule pump 9a is provided for this purpose, such as a vacuum pump. In the preferred variant, the dispensing circuit leads to at least one water dispensing outlet detailed below, and an independent circuit between the capsule 11 and the pump 9a which leads to an independent outlet 10a, called the capsule dispensing outlet 10a.

The machine 1 preferably comprises a storage drawer 11a for used capsules 11. In particular, the drawer 11a is arranged behind the dispensing point 10, above and behind the dispensing holder 5a. Advantageously, this makes it possible to provide a voluminous storage space.

Now concerning the dispensing circuit of the machine 1, it comprises a heating section 12 comprising a heating device 13 configured to heat the dispensed water. The heater 13 can be around the corresponding pipe or resistors can be in the water flow. A prior art equipment can be used as a heater.

In the preferred variant, a temperature probe 13a is provided for better control of the heating device 13 in order to reach a given target temperature.

The water which passes through this section is heated and is then dispensed as a beverage, in particular via a hot water dispensing outlet 10b. This could be a dispensing of hot water into the container, for example for use with a tea bag.

Preferably, at least one hot water pump 9b is provided at the level of the hot water dispensing outlet 10b upstream of the heating device 13 and/or downstream of the heating device 13 to facilitate the drawing of hot water. In the case of using a capsule 11, the contents of the capsule 11 are poured into the container to be mixed with hot water. It may be concentrated tea or coffee. Corresponding capsules 11 can therefore be supplied to the user of the machine 1.

The dispensing circuit further comprises a cooling section 14 including a cooling device 15 configured to cool the dispensed water. In particular, a corresponding pipe (14) can pass through a refrigerated chamber and/or cooperate with at least one coil 15a associated with the cooling device 15. A prior art equipment can be used as a cooling device.

In particular, the machine comprises a water tank 2a, for example made of stainless steel, forms a refrigerated chamber, here traversed by a coil 15a of the cooling device 15, and a water pipe passes in or around the tank 2a and/or near said coil 15a.

In the preferred variant, a temperature sensor 14b is provided in the pipe (14) for better cooling control in order to reach a given target temperature.

The water from the pipe (14) comes out at the dispensing point 10 through a cold water dispensing outlet 10c (or cold water outlet 10c). Preferably, at least one cold water pump 9c is provided at the level of the cold water outlet 10c to facilitate the drawing of cold water. Likewise, the water that passes through this section is cooled and is then dispensed as a beverage. It can be a dispensing of cold water or, in the case of a capsule used, a concentrated fruit juice. Corresponding capsules 11 can therefore be supplied to the user of the machine 1.

The dispensing circuit further comprises a carbonation section 16 comprising a carbonation device 17 configured to dissolve CO₂ in the water to be dispensed. In particular, this is an installation for introducing CO₂ into the water to be dispensed in order to dissolve it there. This mechanism is known in itself and will not be discussed further.

According to a variant, the machine comprises a removable CO₂ cartridge 18 connected to the carbonation device 17. In particular, it is a CO₂ cartridge 18 sized and corresponding to a mounting part 19 of the machine. For example, the CO₂ cartridge measures H180×W50×D50 mm. Corresponding CO₂ cartridges can therefore be supplied to the user of machine 1.

In particular, the machine comprises one or said tank 2a that is closed, preferably under pressure, associated with a CO₂ stirrer (17) immersed in the tank 2a. A pressurizing module 19a is provided to put the tank under pressure and facilitate the solubilization of CO₂ in the water to be dispensed.

The water from the carbonation section 16 comes out via a specific pipe 16b at the dispensing point 10 through a carbonated cold water dispensing outlet 10d (or carbonated water outlet 10d). Preferably, at least one carbonated water pump 9d is provided at the level of the carbonated water outlet 10d to facilitate the drawing of carbonated water.

In one aspect, the cooling section 14 is combined with the carbonating section 16, so that a cold carbonated drink can be dispensed. In particular, the same tank 2a is provided for the cooling 14 and carbonation sections 16, and allows water to be refrigerated and carbonated, preferably under pressure.

Advantageously, this arrangement makes it possible to produce a carbonated cold drink. In addition, the low temperature of the drink allows more dissolved CO₂ to be retained so that the resulting beverage is carbonated more than a beverage at room temperature.

The tank 2a is traversed by said coil 15a so that the water in the tank 2a is cooled significantly by the large contact surface between said coil 15a and the tank 2a. In addition, pressurization further improves carbonation.

In the preferred variant, a temperature sensor 14a is provided in the tank 2a for better cooling control in order to reach a given target temperature.

Reference A relates to a power supply board and reference RV relates to a radiator and a fan of the cooling device 15.

The reference E relates to an electronic card and reference EF relates to a front electronic card.

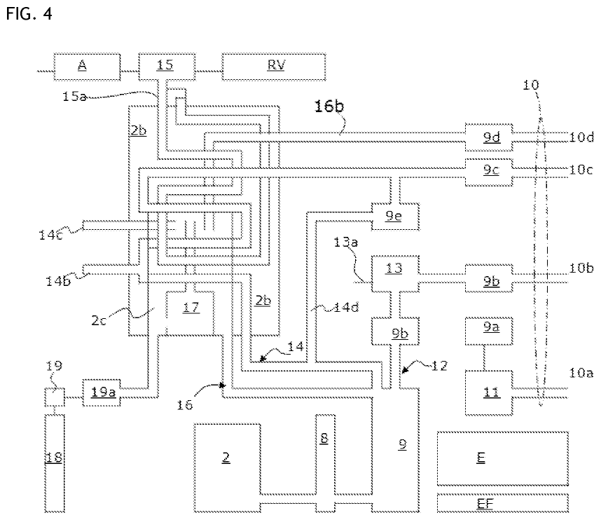

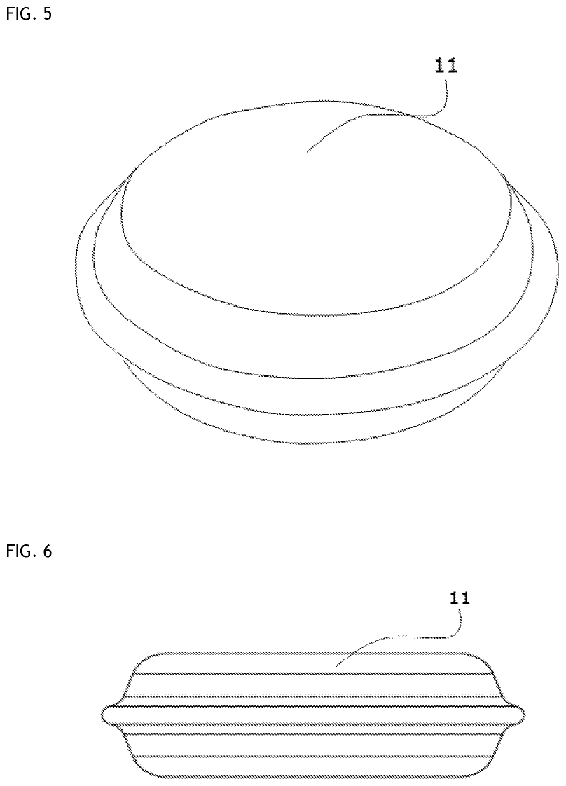

In another variant of the machine which can be illustrated by FIG. 4, instead of the steel tank 2a, a tank forming an ice bank 2b is provided. Inside this tank 2b, there is an additional compartment 2c for the carbonation section. This is a second reservoir, particularly for the preparation of carbonated cold water.

The ice bank prevents water stagnation and allows a continuous dispensing of a large quantity of cold water. The “ice bank” cooling system includes, for example, two coils, one made of stainless steel or copper and the other made of copper, immersed in a tank filled with water. The copper coil containing the refrigerant gas freezes the water in the tank, producing a reserve of cold which in turn cools the potable water circulating inside the other coil, made of stainless steel or copper. The device is thus not only more efficient, but also the hygiene and the quality of the water are assured because the latter circulates relentlessly inside the reservoirs without ever stopping in an embodiment.

In addition, a cold temperature probe 14c is provided in the compartment 2c, here instead of a probe 14a.

Furthermore, one can provide in this variant a bypass 14d from the main pump 9. This bypass 14d can be associated with another mini-pump 9e with a specific dispensing outlet or preferably a dispensing outlet connected to another outlet (10c). This bypass allows the water to circulate continuously in the cooling section 14.

Turning now to the general constitution of the machine 1, it comprises a machine body block 21 and two side blocks one in front of the other. Among the side blocks, the front block is formed by the carafe (2), and the rear block 22 forms a compartment, the front face of which is formed by the carafe (2). The posterior block 22 has no front closure, and is shaped to be closed by the carafe (2). This facilitates the filling of the carafe and the change of consumable in the rear block 22.

In the illustrated variant, the posterior block forms a gas cartridge housing 18. Thus, the mounting part 19 of the CO₂ cartridge 18 is provided in the posterior block 22 to connect the CO₂ cartridge to the carbonation device 17.

According to a variant, the body block 21 comprises a side sub-block or side block 23 closed by a side flap 24 and/or an opposite second side sub-block 23a hidden by the carafe (2). In particular, the side block 23a forms a filter cartridge housing (8). Thus, a corresponding mounting device (not shown) is provided in the side block 23a.

Regarding now the control system of the machine 1, it is based on a control panel 25 associated with control electronics. The control system is configured to control the pumps 9, 9a-9d and solenoid valves (not shown) for selecting the circuit required for the dispensing of beverage. Sensors can be considered to optimize the control, for example to alert on the insufficient amount of water or the absence of capsule 11 in the capsule housing if necessary.

The control panel 25 is configured to select a hot drink, a cold drink or a carbonated drink, by activating at least one of said sections. To this end, control buttons 26 are provided to select the desired drink, and, if necessary after inserting the required capsule 11, the control electronics start the preparation and dispensing of the beverage. It may be for example, from left to right, a cold water button, a carbonated and fresh water button, a hot water button with corresponding icons.

According to specificities of embodiments of the invention:

the beverage is dispensed through specific pipes 10a, 10b, 10c, 10d. Independent hot and cold water pipes prevent heating cold drinks served immediately after hot drinks, and vice versa; an independent capsule pipe ensures that there are no capsule residues when dispensing water just after a capsule beverage;

the structure includes both a tank (carafe 2) and a cooling and carbonating tank 2a separated from tank 2 in one embodiment. The water can be either heated or, separately, cooled and optionally carbonated in the tank 2;

the cooling is done by coil or ice bank. Cooling appears to be more efficient than blowing fresh air like in some prior art solutions;

Additional pumps are on separate pipes, preferably on each pipe. A capsule pump enables a simplified assembly of dispensing the content of the capsule without having to pass water through the capsule. Separate pumps enable to operate the structure with separate heating, cooling/carbonation sections.

What is claimed is:

1. A domestic machine for dispensing beverage, comprising a removable water tank, a water filtration system, at least one circulation pump for moving the water to a dispensing point associated with a beverage capsule, the machine comprising a heating section comprising a heater configured to heat the water to be dispensed, a cooling section comprising a cooling device configured to cool the water to be dispensed, and a carbonating section comprising a carbonating device configured to dissolve CO₂ in the water to be dispensed, the machine comprising a control panel for selecting a hot drink, a cold drink or a carbonated drink, by activating at least one of said sections.

2. The machine according to claim 1, wherein the cooling section is combined with the carbonating section, so as to enable dispensing a cold carbonated drink.

3. The machine according to claim 1, comprising an internal tank forming a refrigerated chamber and/or cooperating with at least one coil of the cooling device; and further cooperating with means for dispensing cold water and carbonated cold water.

4. The machine according to claim 1, comprising a removable CO₂ cartridge connected to the carbonating device.

5. The machine according to claim 1, wherein the filtration system includes a removable filter cartridge.

6. The machine according to claim 1, wherein the water tank is in the form of a carafe having a substantially prismatic body, comprising a valve on a lower face cooperating with a sampling pipe.

7. The machine according to claim 6, wherein the carafe comprises a massive handle arranged on a front face of the machine comprising a dispensing support.

8. The machine according to claim 6, comprising a body block and two side blocks one in front of the other, the front block being formed by the carafe, and the rear block forming a compartment, the front face of which is formed by the carafe.

9. The machine according to claim 7, comprising a body block and two side blocks one in front of the other, the front block being formed by the carafe, and the rear block forming a compartment, the front face of which is formed by the carafe.

10. The machine according to claim 8, comprising a removable CO₂ cartridge connected to the carbonating device, wherein the rear block forms a gas cartridge housing.

11. The machine according to claim 1, wherein the body block comprises a side sub-block closed by the carafe.

12. The machine according to claim 1, comprising a capsule dispensing outlet separated from at least one other dispensing outlet.

13. The machine according to claim 1, comprising separate outlets dispensing capsule, dispensing hot water, and dispensing cold water.

14. The machine according to claim 1, wherein at least one dispensing pipe linked to cold water is separated from at least one dispensing pipe linked to hot water.

15. The machine according to claim 1, comprising separate pumps on separate dispensing pipes.

16. A method of assembling a machine combining a beverage carbonation means, a juice production means, and a hot beverage production means compactly in a domestic machine according to claim 1.
